(19) United States
(12) Patent Application Publication
(10) Pub. No.: US 2025/0238798 A1
(43) Pub. Date: Jul. 24, 2025

(54) SYSTEMS AND METHODS TO SHARE DATA WITH A 3RD PARTY WALLET THROUGH THE AUTHORIZATION MESSAGE

(71) Applicant: Capital One Services, LLC, McLean, VA (US)

(72) Inventors: Jeffrey Carlyle WIEKER, Falls Church, VA (US); Jeffrey RULE, Chevy Chase, MD (US); Paul FORT, Westbury, NY (US)

(21) Appl. No.: 18/415,965

(22) Filed: Jan. 18, 2024

(51) Int. Cl. G06Q 20/40; G06Q 20/36

(52) U.S. Cl. CPC G06Q 20/4014; G06Q 20/3674; G06Q 2220/00

(57) ABSTRACT

A system may receiving, by a processor, merchant data pertaining to a user, receiving, by the processor, issuer data pertaining to the user, receiving, by the processor, third party metrics data pertaining to the user, receiving, by the processor, mobile device data for a mobile device associated with the user, applying, by the processor, a machine learning model to the merchant data, issuer data, third-party metrics, and mobile device data to make a fraud prediction, receiving, by the processor, feedback on the fraud prediction; and updating, by the processor, the machine learning model using the feedback as an input.

### FIELD OF THE DISCLOSURE

The present disclosure relates to systems and methods for using a unique user ID that is transmitted through an ISO authorization message to provide data for approving transaction requests.

### BACKGROUND

Online retail accounts for a major portion of commerce. Consumers have long been trending toward a willingness to purchase items based solely off of pictures and descriptions, and have also been trending toward an unwillingness to travel outside of the home to a brick and mortar merchant to make many retail purchases. This trend appears to have been accelerated by the COVID pandemic.

As a result, commerce participants have been adapting in ways to facilitate e-commerce. The digital wallet is once such innovation. Digital wallets store payment methods for consumers, often without requiring storage of sensitive account/credit card data. Digital wallets provide an easy and innovative way for consumers to offer payments for online transactions, but ultimately, transaction processing utilizes traditional card networks and the traditional authorization processes.

With the advent of digital wallets and e-commerce, the risk of fraudulent transactions has increased substantially. Because this increase in fraud is due to online shopping, it is no surprise that the fraud is manifesting through new and ever-changing digital schemes/tactics. Traditional authorization infrastructure and methods are adapting, but are limited in the relevant data available to render transaction authorization decisions.

These and other deficiencies exist. Accordingly, there is a need for creating unique user IDs shared between issuers and digital wallets in ISO authorization messages for the purpose of increasing data available to render transaction authorization decisions.

### SUMMARY OF THE DISCLOSURE

In some aspects, the techniques described herein relate to a method for authorizing transaction requests, the method including the steps of: receiving, by a processor, a provisioning request for a digital wallet; sending, as a result of the provisioning request, a unique user identifier (ID) to the digital wallet; receiving, by the processor, an authorization message from a merchant including: one or more transaction details; and the unique user ID; and transmitting, by the processor, a transaction decision based on the unique user ID.

In some aspects, the techniques described herein relate to a method, further including: generating, by the processor, the unique user ID.

In some aspects, the techniques described herein relate to a method, further including: storing, in a database, the unique user ID.

In some aspects, the techniques described herein relate to a method, wherein the transaction request further includes one or more details regarding authentication of the digital wallet.

In some aspects, the techniques described herein relate to a method, further including: comparing, by the processor, the unique user ID against a database of unique user IDs, each correlated to a user.

In some aspects, the techniques described herein relate to a method, further including: confirming the identity of an owner of the digital wallet by finding a match between the unique user ID and an entry in the database of unique user IDs

In some aspects, the techniques described herein relate to a method, wherein in response to receiving the authorization message including the unique user ID, sending, by the processor, a request for additional information directly to the digital wallet.

In some aspects, the techniques described herein relate to a method, wherein the transaction decision is further based on a response to the request for additional information sent to the digital wallet.

In some aspects, the techniques described herein relate to a method, further including: sending, via the processor, the unique user ID from the authorization message to a central processor connected to a plurality of issuers or a plurality of banks.

In some aspects, the techniques described herein relate to a method, further including: receiving, via the processor, feedback from the central processor, the feedback including user identity information for the unique user ID from the authorization message from one or more of the plurality of issuers or a plurality of banks.

In some aspects, the techniques described herein relate to a method for authorizing transaction requests, the method including the steps of: receiving, by a processor, a provisioning request for a digital wallet; sending, as a result of the provisioning request, a unique user identifier (ID) to the digital wallet; receiving, by the processor, a merchant authorization message; sending, by the processor and as a result of the merchant authorization message, a first authorization message to the digital wallet, the first authorization message including a unique user ID request; receiving, by the processor, a second authorization message from the digital wallet, the second authorization message including the unique user ID; and transmitting, by the processor, a transaction decision based on the unique user ID.

In some aspects, the techniques described herein relate to a system for authorizing transaction requests, the system including: a processor configured to: receive a provisioning request for a digital wallet; send a unique user identifier (ID) to the digital wallet; receive an authorization message from a merchant including: one or more transaction details; and the unique user ID; and transmitting, by the processor, a transaction decision based on the unique user ID.

In some aspects, the techniques described herein relate to a system, further including: a database configured to store the unique user ID.

In some aspects, the techniques described herein relate to a system, wherein the transaction request further includes one or more details regarding authentication of the digital wallet.

In some aspects, the techniques described herein relate to a system, wherein the processor is further configured to compare the unique user ID against a database of unique user IDs, each correlated to a user.

In some aspects, the techniques described herein relate to a system, wherein the processor is further configured to confirm the identity of an owner of the digital wallet by finding a match between the unique user ID and an entry in the database of unique user IDs.

In some aspects, the techniques described herein relate to a system, wherein in response to receiving the authorization message including the unique user ID, the processor is configured to send a request for additional information directly to the digital wallet.

In some aspects, the techniques described herein relate to a system, wherein the transaction decision is further based on a response to the request for additional information sent to the digital wallet.

In some aspects, the techniques described herein relate to a system, wherein the processor is further configured to send, via the processor, the unique user ID from the authorization message to a central processor connected to a plurality of issuers or a plurality of banks.

In some aspects, the techniques described herein relate to a system, wherein the processor is further configured to receive feedback from the central processor, the feedback including user identity information for the unique user ID from the authorization message from one or more of the plurality of issuers or a plurality of banks.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 illustrates a system for sharing a unique user ID between an issuer and a digital wallet in an ISO authorization message according to an exemplary embodiment.

FIG. 2 illustrates a sequence of operations for sharing a unique user ID between an issuer and a digital wallet in an ISO authorization message according to an exemplary embodiment.

FIG. 3 illustrates a sequence of operations for sharing a unique user ID between an issuer and a digital wallet in an ISO authorization message according to an exemplary embodiment.

FIG. 4 illustrates a system for using a central processor to share a unique user ID between an issuer and a digital wallet in an ISO authorization message according to an exemplary embodiment.

FIG. 5 is a schematic representation of an issuer backend according to an exemplary embodiment.

FIG. 6 illustrates a sequence of operations for sharing a unique user ID between an issuer and a digital wallet in an ISO authorization message according to an exemplary embodiment.

### DETAILED DESCRIPTION

The following description of embodiments provides non-limiting representative examples referencing numerals to particularly describe features and teachings of different aspects of the invention. The embodiments described will be recognized as capable of implementation separately, or in combination, with other embodiments from the description of the embodiments and the features and teachings of any embodiment can be interchangeably combined with the features and teachings of any other embodiment. A person of ordinary skill in the art reviewing the description of embodiments will be able to learn and understand the different described aspects of the invention. The description of embodiments will facilitate understanding of the invention to such an extent that other implementations, not specifically covered but within the knowledge of a person of skill in the art having read the description of embodiments, will be understood to be consistent with an application of the invention.

Furthermore, the described features, advantages, and characteristics of the embodiments may be combined in any suitable manner. A person of ordinary skill in the art will recognize that the embodiments may be practiced without one or more of the specific features or advantages of an embodiment. In other instances, additional features and advantages may be recognized in certain embodiments that may not be present in all embodiments. A person of ordinary skill in the art will understand that the described features, advantages, and characteristics of any embodiment can be interchangeably combined with the features, advantages, and characteristics of any other embodiment.

The present invention provides systems and methods by which issuers may increase the amount of data available on which to make a credit card authorization decisions. Current authorization processes require decisions on limited information contained within ISO messages sent through card authorization networks. The card authorization process is established and mature. Therefore, any significant deviations from this process requires creation of new bespoke systems that will not replace traditional card networks and therefore are likely to be largely duplicative. Any such system will necessarily run in parallel with traditional card authorization network rails, meaning that any system created for additional functionality/information sharing will be cost inefficient as well as a burden on networks and computing resources.

The present invention provides additional and new data for use in card authorization decisions but without the inefficiencies in creating new systems for sharing additional information. Exemplary embodiments disclosed herein pertain to sharing of unique user IDs between issuer backends and digital wallets through ISO authorization messages sent within the existing card network architecture. As a result, the unique user IDs are passed efficiently without taxing existing systems or requiring the need for additional network resources. The unique user IDs provide information on which issuers may make authorization decisions beyond traditional card number, CVV, expiration date, transaction amount, etc.

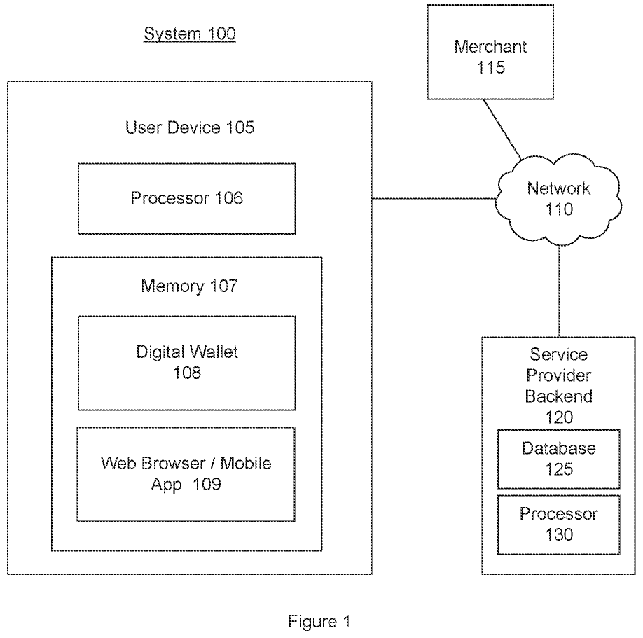

FIG. 1 illustrates a system 100 for sharing a unique user ID between an issuer and a digital wallet in an ISO 20022 authorization message for the purpose of assisting in making decisions on transaction authorization requests. The system 100 may include a user device 105, a network 110, a service provider backend 120, and a merchant 115. Although FIG. 1 illustrates single instances of components of system 100, system 100 may include any number of components.

System 100 may include a user device 105. The user device 105 may include one or more processors 106 and memory 107. Memory 107 may include one or more applications, such as web browser and/or mobile app 109 as well as digital wallet 108. Web browser and/or mobile app 109 may be capable of displaying a merchant or e-commerce webpage. The user device 105 may be in data communication with any number of components of system 100. For example, the user device 105 may transmit data via network 110 to merchant 115, which may comprise of browsing a merchant website and/or attempting a purchase transaction from merchant 115. Further, digital wallet 108 may communicate with merchant 115 and/or service provider backend 120. Merchant 115 may be any consumer-based entity and the merchant website may be any website that facilitates transactions for goods and/or services. User device 105 may also transmit data via network 110 to processor 130 and/or database 125 of service provider backend 120. Without limitation, the user device 105 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an ATM, or other device. The device 105 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 105 may include processing circuitry and may contain additional components, including processors, memories, error and parity/CRC checkers, data encoders, anticollision algorithms, controllers, command decoders, security primitives and tamper-proofing hardware, as necessary to perform the functions described herein. The device 105 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

System 100 may include a network 110. In some examples, network 110 may be one or more of a wireless networks, a wired network or any combination of wireless network and wired network, and may be configured to connect to any one of components of system 100. For example, the device 105 may be configured to connect to service provider backend 120 via network 110. In some examples, network 110 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, near field communication (NFC), Radio Frequency Identification (RFID), Wi-Fi, and/or the like.

In addition, network 110 may include, without limitation, telephone lines, fiber optics, IEEE Ethernet 902.3, a wide area network, a wireless personal area network, a LAN, or a global network such as the Internet. In addition, network 110 may support an Internet network, a wireless communication network, a cellular network, or the like, or any combination thereof. Network 110 may further include one network, or any number of the exemplary types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more examples, network 110 may comprise a plurality of interconnected networks, such as, for example, the Internet, a service provider's network, a cable television network, corporate networks, such as credit card association networks, and home networks.

System 100 may include service provider backend 120 which may comprise one or more servers or other computing devices. In some examples, the one or more servers may include one or more processors, represented as processor 130 and coupled to memory, represented as database 125. The server(s) may be configured as a central system, server or platform to control and call various data at different times to execute a plurality of workflow actions.

In some examples, the server(s) can be a dedicated server computer, such as bladed servers, or can be personal computers, laptop computers, notebook computers, palm top computers, network computers, mobile devices, wearable devices, or any processor-controlled device capable of supporting the system 100. While FIG. 1 illustrates a single server, it is understood that other embodiments can use multiple servers or multiple computer systems as necessary or desired to support the users and can also use back-up or redundant servers to prevent network downtime in the event of a failure of a particular server.

The server may include an application in memory comprising instructions for execution thereon. For example, the application may comprise instructions for execution on the server. The application may be in communication with any components of system 100. For example, the server may execute one or more applications that enable, for example, network and/or data communications with one or more components of system 100 and transmit and/or receive data. Without limitation, the server may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. The server also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server may include processing circuitry and may contain additional components, including processors, memories, error and parity/CRC checkers, data encoders, anticollision algorithms, controllers, command decoders, security primitives and tamper-proofing hardware, as necessary to perform the functions described herein. The server may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

System 100 may include one or more databases 125. The database 125 may comprise a relational database, a non-relational database, or other database implementations, and any combination thereof, including a plurality of relational databases and non-relational databases. In some examples, the database 125 may comprise a desktop database, a mobile database, or an in-memory database. Further, the database 125 may be hosted internally by any component of system 100 or the database 125 may be hosted externally to any component of the system 100 by a cloud-based platform, or in any storage device that is in data communication with the device 105 and backend 120. In some examples, database 125 may be in data communication with any number of components of system 100. For example, the processor 106 in data communication with the digital wallet 108 may be configured to transmit one or more requests for the requested data from database 125 via network 110.

In some examples, exemplary procedures in accordance with the present disclosure described herein can be performed by a processing arrangement and/or a computing arrangement (e.g., computer hardware arrangement). Such processing and/or computing arrangement can be, for example entirely or a part of, or include, but not limited to, a computer and/or processor that can include, for example one or more microprocessors, and use instructions stored on a computer-accessible medium (e.g., RAM, ROM, hard drive, or other storage device). For example, a computer-accessible medium can be part of the memory of the user device 105, service provider backend 120, and/or database 125, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

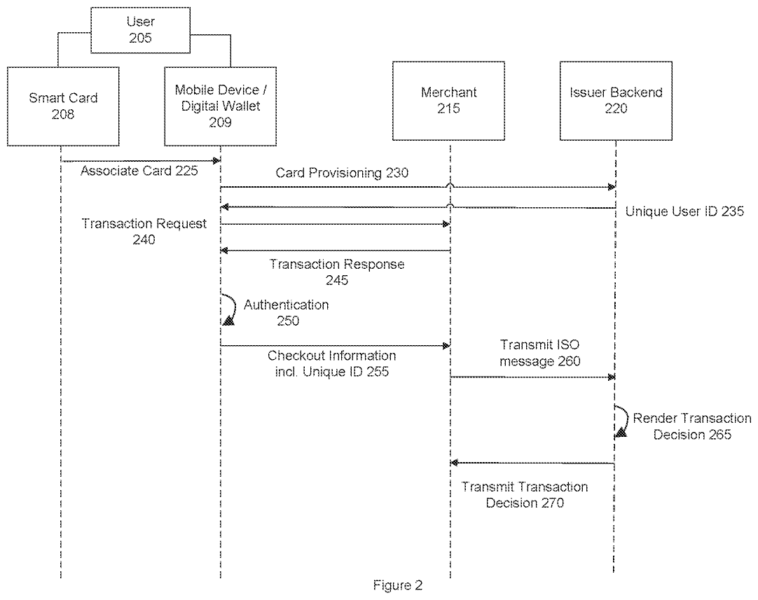

The sequence diagram of FIG. 2 illustrates an exemplary application of embodiments of the invention in conjunction with the system 100 of FIG. 1. In the scenario set forth in FIG. 2, a user 205 has a smart card 208 and a mobile device/digital wallet 209. The mobile device/digital wallet 209 is in communication with a merchant 215 and in some embodiments, an issuer backend 220. Mobile device/digital wallet 209 may be a personal computer, smart phone, smart watch, or any other network enabled computing device. Mobile device/digital wallet 209 may include memory, a network communication, an interactive user interface, and a processor capable of running one or more software applications and a digital wallet. Smart card 208 may be any chip enabled credit card or the like. Smart card 208 may be in communication with mobile device/digital wallet 209 via Bluetooth, NFC, or any other suitable short range communication protocol.

Issuer backend 220 may include one or more processors and may be in communication with mobile device/digital wallet 209 and merchant 215. Backend 220 may be configured to transmit to and receive data from merchant 215 pertaining to a purchase transaction, as well as mobile device/digital wallet 209.

Merchant 215 may include one or more processors and memory, as well as storage. It may be configured to run one or more websites, apps, etc. It may be further configured to provide a consumer facing sales interface that enables consumer shopping and purchase transactions of one or more goods or services on a website or app associated with merchant 215. It may be configured to communicate with backend 220 in order to transmit transaction requests as well as share consumer data.

User 205 may hold smart card 208 that may be associated with an issuer and/or one or more financial and/or credit accounts, etc. with that issuer. User 205 may also have a mobile device/digital wallet 209. When user 205 makes online purchases, he or she may be required to enter payment information in an interface provided by merchant 215. Entry of this information may be cumbersome and time consuming as it requires finding the desired smart card, which often is not on the user 205 at the time of the attempted purchase. Then user 205 must manually enter the card information including the name on the card, the card number, an expiration date, and the CVV number. A user may be willing to follow this process if he or she only occasionally shops online. However, if a person frequently shops online, this process becomes a real barrier, especially when compared to the credit card usage process at a brick and mortar store. In those instances, a consumer usually inserts a card into or taps the card against a POS terminal. That is the sole requirement-no name entry, card number entry, etc. Thus, user 205 may seek a better and more efficient way to use his or her smart card 208 in connection with online purchases. The digital wallet is an answer to the problems with traditional online purchase transactions. Digital wallets store a user's cards digitally, thereby obviating the need to manually enter all of the credit card information each time an online transaction is attempted. When an online purchase transaction is attempted, a user may simply open his or her digital wallet (or otherwise be prompted to use his or her digital wallet). Then the user may select a digital card for payment, the digital card representing an financial account held with an issuer/bank. The user is not required to then manually enter any credit card information, but may be required to perform some sort of authentication. Thus, at step 225, user 205 may be incentivized to associate smart card 208 with a digital wallet of mobile device/digital wallet 209.

Associating smart card 208 with mobile device/digital wallet 209 may normally entail manually entering the card details much like a traditional online purchase transaction. The difference, of course, is that this information only has to be entered once as opposed to every time an online purchase is made. However, in some embodiments, smart card 208 may be associated with mobile device/digital wallet 209 through any technological means, including but not limited to NFC, Bluetooth, etc. The association of smart card 208 may permit and/or enable mobile device/digital wallet 209 to collect and/or store information pertaining to user 205 as well as the user's account(s) associated with smart card 208.

As a result of card association at step 225, card provisioning may occur at step 230. In order for a digital wallet to function, there often is a backend setup required between the digital wallet and the issuer/bank, in this case between mobile device/digital wallet 209 and issuer backend 220. In the case of many digital wallets, this process involves digital tokenization of each smart card associated with the digital wallet. The tokenization process may involve the mobile device/digital wallet 209 sending a provisioning request to issuer backend 220 that may include sending the card details for verification/authorization. If these card details are confirmed and issuer backend 220 is confident that the card is correct, it may provide a digital token that represents the card, such that mobile device/digital wallet 209 is not required to store sensitive card information. In future transactions, mobile device/digital wallet 209 may provide the digital token that represents the account instead of the sensitive card information.

In exemplary embodiments, issuer backend 220 may create a unique user ID. This unique user ID may correspond to user 205, to mobile device/digital wallet 209, to smart card 208, or to any combination thereof. Issuer backend 220 may determine a scheme whereby a single unique user ID is sufficient for a given user, or may want multiple unique user ID for as many smart card/accounts as held by a given user. Similarly, in some exemplary embodiments, a user may have different unique user IDs for the same smart card/account on a per-electronic device basis. Other combinations or schemes may be possible. In some exemplary embodiments, a 3^{rd} party may be responsible for creating unique user IDs instead of the issuer backend 220. To the extent that systems and methods disclosed herein become an industry standard, there could be an accepted third-party clearinghouse for unique user IDs.

Issuer backend 220 may store the unique user ID created in response to the card provisioning at step 230. At step 235, issuer backend 220 may send the unique user ID to the mobile device/digital wallet 209 for integration with the smart card 208 or with a digital token representing smart card 208 (or an account for smart card 208). The digital wallet may be responsible for storing and maintaining the unique user ID on user 205's end of the system/method architecture.

At 240, mobile device/digital wallet 209 may transmit a transaction request to merchant 215. User 205 may shop for goods on mobile device/digital wallet 209. The shopping may be directly connected to merchant 215. For example, the shopping may take place on a website hosted by merchant 215 or an app developed and/or supported/hosted by merchant 215. Shopping on mobile device/digital wallet 209 may include adding one or more products to a virtual cart and then initiating a virtual checkout process for those one or more products. The act of checking out with one or more products may result in mobile device/digital wallet 209 transmitting a transaction request to merchant 215 at step 240. In response to the transaction request of 240, merchant 215 may provide a transaction response at step 245. The transaction response may include merchant 215 requesting a method of payment. This step may also include any sort of login to a user account for a merchant website and/or providing other credentials.

As a result of merchant 215 requesting a form of payment, user 205 may select/open his or her digital wallet. In some embodiments, a digital wallet may monitor attempted purchase transaction and provide a pop-up message offering use of a digital wallet to provide a form of payment in response to merchant 215. In any event, user 205 may select a smart card/account from the digital wallet that he or she wishes to use to complete the requested transaction. In this example, user 205 may select smart card 208, or a digital token representing smart card 208, from his or her digital wallet.

Mobile device/digital wallet 209 may require some form of authentication at step 250 prior to allowing use of any associated card/account. This authentication may include facial recognition, fingerprint, voice print, or any other potential biometric. The authentication may also include more traditional user ID and password combinations. In some embodiments, there may be combinations of authentication required as well as stepped up and/or stepped down authentication depending on any number of factor. For instance, after initial authentication, digital wallet may send a text with a verification code to an associated phone number and/or email address as a form of multi-factor authentication.

Once mobile device/digital wallet 209 has successfully authenticated user 205 at step 250, mobile device/digital wallet 209 may provide an authorization message merchant 215. This authorization message may conform to an industry standard format such as ISO 20022. The checkout information may include card information, or in some instances, the digital token representing smart card 208. The unique user ID may also be included within the ISO 20022 authorization message, as opposed to sending the unique user ID off of network rails. In some embodiments, the mobile device/digital wallet 209 may provide checkout information inclusive of the unique user ID agnostic of any ISO authorization message. Some or all of the information conveyed at step 255 may be encrypted.

Merchant 215 may, in turn, send an ISO 20022 authorization message to issuer backend 220. This authorization message may be part of the traditional process and established network rails. For example, the authorization message may travel through a card network for routing to issuer backend 220. Traditional processes and established network rails require messages in a standardized format. These messages historically conformed to ISO 8583 which may be an international standard for financial transaction card originated interchange messaging. This standard message format exists so that different systems can be integrated and together process credit card transactions. ISO 8583 may have limited size to transmit information pertaining to an authorization request.

ISO 20022 may be a new standardized message format for systems to send and receive information for the purpose of processing credit card authorization request. ISO 20022 is XML-based and lends itself to expanded data sharing. The ISO 20022 authorization message sent by merchant 215 and step 260 may include the unique user ID from mobile device/digital wallet 209. Transmitting a unique user ID with an ISO 8583 authorization message is not possible given size constraints. Indeed, prior to the present disclosure, in order for merchant 215 to transmit a unique user ID to issuer backend 220, issuer backend 220 would need to create a bespoke system to convey that information, and that information would necessarily be transmitted off of (outside of) traditional network rails. Any bespoke systems for sharing information are resource and time inefficient, as well as largely redundant (but—for technological limitations). Transferring a unique user ID in an ISO 20022 authorization message on the network rails (e.g., through a card network), addresses a technological limitation and represents an improvement to computing systems, data security, and fraud prevention.

Once issuer backend 220 receives the ISO 20022 authorization message (routed through a card network), issuer backend 220 may render a transaction decision. This decision may consider traditional metrics for rendering an authorization decision such as if the digital token is correct and resolves to an active account in good standing. For example, if a transaction amount exceeds the available limit on an account, then issuer backend 220 will refuse the authorization request. Similarly, if a smart card 208 is expired, the account numbers are incorrect, the CVV is incorrect, or any other informational mismatch, issuer backend 220 may refuse the authorization request. These bases for refusal generally have nothing to do with fraud prevention (unless, for example, a transaction amount exceeds an amount that flags for potential fraud). ISO authorization messages are traditionally limited to information that does not reveal much in the way of potential fraud. However, with the unique user ID included in the ISO 20022 authorization message, issuer backend 220 has additional data with which to render a transaction decision, and this information may be indicative of attempted fraud. Issuer backend 220 may take the unique user ID provided in the ISO 20022 authorization message and compare it against a database of unique user IDs. This database of unique user IDs may be correlated with one or more of a user, an account, and an electronic device. For example, user 205 may be Bob Smith, and he may hold an account corresponding to smart card 208 and a mobile device/digital wallet 209. When Bob Smith attempts an online transaction with his digital wallet, issuer backend 220 may receive an ISO 20022 authorization message with the transaction particulars and a unique user ID. In this example the unique user ID is 1234, but this number is simply for the sake of example, real unique user IDs maybe alphanumeric and may be longer. Issuer backend 220 may take the 1234 unique user ID and search its database of user IDs. If issuer backend 220 fails to find ID 1234, then it may reject the authorization request as potentially fraudulent. This is true even if the traditional transaction information all checks out. In another embodiment, issuer backend 220 may locate ID 1234 in its database, but that ID may belong to Fred Jones. This may also cause issuer backend 220 to reject the authorization request as potentially fraudulent. The same may result if the user ID is mismatched in any way. For example, the user ID may match user 205, but not the mobile device/digital wallet 209, vice versa, or any other potential discrepancy. In the event that issuer backend is able to locate the provided unique user ID in its database and the number/information all match and are verified, then issuer backend may approve the authorization request at step 265. At step 270, issuer backend 220 may transmit the transaction decision to merchant 215, which may complete the online purchase by user 205. Because this process is able to be conducted through the existing credit card authorization infrastructure, the transaction decision of step 265 and the transmission of that decision at 270 may occur in real-time, or at least substantially the same time as traditional credit card authorizations. Put another way, the sequence of FIG. 2 may not add any time to credit card transaction processing, and therefore may be seamless to user 205 and merchant 215.

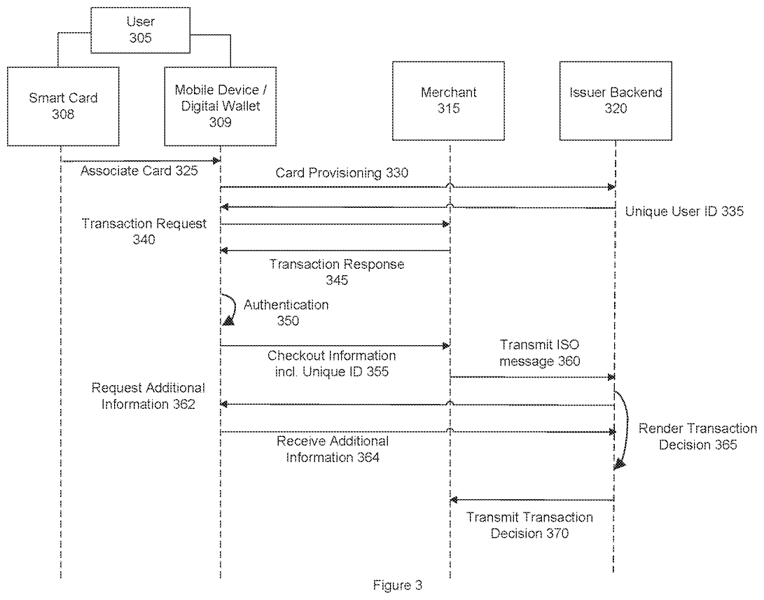

The sequence diagram of FIG. 3 illustrates an exemplary application of embodiments of the invention in conjunction with the system 100 of FIG. 1. In the scenario set forth in FIG. 3, a user 305 has a smart card 308 and a mobile device/digital wallet 309. The mobile device/digital wallet 309 is in communication with a merchant 315 and in some embodiments, an issuer backend 320. Mobile device/digital wallet 309 may be a personal computer, smart phone, smart watch, or any other network enabled computing device. Mobile device/digital wallet 309 may include memory, a network communication, an interactive user interface, and a processor capable of running one or more software applications and a digital wallet. Smart card 308 may be any chip enabled credit card or the like. Smart card 308 may be in communication with mobile device/digital wallet 309 via Bluetooth, NFC, or any other suitable short range communication protocol.

Issuer backend 320 may include one or more processors and may be in communication with mobile device/digital wallet 309 and merchant 315. Backend 320 may be configured to transmit to and receive data from merchant 315 pertaining to a purchase transaction, as well as mobile device/digital wallet 309.

Merchant 315 may include one or more processors and memory, as well as storage. It may be configured to run one or more websites, apps, etc. It may be further configured to provide a consumer facing sales interface that enables consumer shopping and purchase transactions of one or more goods or services on a website or app associated with merchant 315. It may be configured to communicate with backend 320 in order to transmit transaction requests as well as share consumer data.

User 305 may hold smart card 308 that may be associated with an issuer and/or one or more financial and/or credit accounts, etc. with that issuer. User 305 may also have a mobile device/digital wallet 309. When user 305 makes online purchases, he or she may be required to enter payment information in an interface provided by merchant 315. Entry of this information may be cumbersome and time consuming as it requires finding the desired smart card, which often is not on the user 305 at the time of the attempted purchase. Then user 305 must manually enter the card information including the name on the card, the card number, an expiration date, and the CVV number. A user may be willing to follow this process if he or she only occasionally shops online. However, if a person frequently shops online, this process becomes a real barrier, especially when compared to the credit card usage process at a brick and mortar store. In those instances, a consumer usually inserts a card into or taps the card against a POS terminal. That is the sole requirement-no name entry, card number entry, etc. Thus, user 305 may seek a better and more efficient way to use his or her smart card 308 in connection with online purchases. The digital wallet is an answer to the problems with traditional online purchase transactions. Digital wallets store a user's cards digitally, thereby obviating the need to manually enter all of the credit card information each time an online transaction is attempted. When an online purchase transaction is attempted, a user may simply open his or her digital wallet (or otherwise be prompted to use his or her digital wallet). Then the user may select a digital card for payment, the digital card representing an financial account held with an issuer/bank. The user is not required to then manually enter any credit card information, but may be required to perform some sort of authentication. Thus, at step 325, user 305 may be incentivized to associate smart card 308 with a digital wallet of mobile device/digital wallet 309.

Associating smart card 308 with mobile device/digital wallet 309 may normally entail manually entering the card details much like a traditional online purchase transaction. The difference, of course, is that this information only has to be entered once as opposed to every time an online purchase is made. However, in some embodiments, smart card 308 may be associated with mobile device/digital wallet 309 through any technological means, including but not limited to NFC, Bluetooth, etc. The association of smart card 308 may permit and/or enable mobile device/digital wallet 309 to collect and/or store information pertaining to user 305 as well as the user's account(s) associated with smart card 308.

As a result of card association at step 325, card provisioning may occur at step 330. In order for a digital wallet to function, there often is a backend setup required between the digital wallet and the issuer/bank, in this case between mobile device/digital wallet 309 and issuer backend 320. In the case of many digital wallets, this process involves digital tokenization of each smart card associated with the digital wallet. The tokenization process may involve the mobile device/digital wallet 309 sending a provisioning request to issuer backend 320 that may include sending the card details for verification/authorization. If these card details are confirmed and issuer backend 320 is confident that the card is correct, it may provide a digital token that represents the card, such that mobile device/digital wallet 309 is not required to store sensitive card information. In future transactions, mobile device/digital wallet 309 may provide the digital token that represents the account instead of the sensitive card information.

In exemplary embodiments, issuer backend 320 may create a unique user ID. This unique user ID may correspond to user 305, to mobile device/digital wallet 309, to smart card 308, or to any combination thereof. Issuer backend 320 may determine a scheme whereby a single unique user ID is sufficient for a given user, or may want multiple unique user ID for as many smart card/accounts as held by a given user. Similarly, in some exemplary embodiments, a user may have different unique user IDs for the same smart card/account on a per-electronic device basis. Other combinations or schemes may be possible. In some exemplary embodiments, a 3rd party may be responsible for creating unique user IDs instead of the issuer backend 320. To the extent that systems and methods disclosed herein become an industry standard, there could be an accepted third-party clearinghouse for unique user IDs.

Issuer backend 320 may store the unique user ID created in response to the card provisioning at step 330. At step 335, issuer backend 320 may send the unique user ID to the mobile device/digital wallet 309 for integration with the smart card 308 or with a digital token representing smart card 308 (or an account for smart card 308). The digital wallet may be responsible for storing and maintaining the unique user ID on user 305's end of the system/method architecture.

At 340, mobile device/digital wallet 309 may transmit a transaction request to merchant 315. User 305 may shop for goods on mobile device/digital wallet 309. The shopping may be directly connected to merchant 315. For example, the shopping may take place on a website hosted by merchant 315 or an app developed and/or supported/hosted by merchant 315. Shopping on mobile device/digital wallet 309 may include adding one or more products to a virtual cart and then initiating a virtual checkout process for those one or more products. The act of checking out with one or more products may result in mobile device/digital wallet 309 transmitting a transaction request to merchant 315 at step 340. In response to the transaction request of 340, merchant 315 may provide a transaction response at step 345. The transaction response may include merchant 315 requesting a method of payment. This step may also include any sort of login to a user account for a merchant website and/or providing other credentials.

As a result of merchant 315 requesting a form of payment, user 305 may select/open his or her digital wallet. In some embodiments, a digital wallet may monitor attempted purchase transaction and provide a pop-up message offering use of a digital wallet to provide a form of payment in response to merchant 315. In any event, user 305 may select a smart card/account from the digital wallet that he or she wishes to use to complete the requested transaction. In this example, user 305 may select smart card 308, or a digital token representing smart card 308, from his or her digital wallet.

Mobile device/digital wallet 309 may require some form of authentication at step 350 prior to allowing use of any associated card/account. This authentication may include facial recognition, fingerprint, voice print, or any other potential biometric. The authentication may also include more traditional user ID and password combinations. In some embodiments, there may be combinations of authentication required as well as stepped up and/or stepped down authentication depending on any number of factor. For instance, after initial authentication, digital wallet may send a text with a verification code to an associated phone number and/or email address as a form of multi-factor authentication.

Once mobile device/digital wallet 309 has successfully authenticated user 305 at step 350, mobile device/digital wallet 309 may provide an authorization message merchant 315. This authorization message may conform to an industry standard format such as ISO 20022. The checkout information may include card information, or in some instances, the digital token representing smart card 308. The unique user ID may also be included within the ISO 20022 authorization message, as opposed to sending the unique user ID off of network rails. In some embodiments, the mobile device/digital wallet 309 may provide checkout information inclusive of the unique user ID agnostic of any ISO authorization message. Some or all of the information conveyed at step 355 may be encrypted.

Merchant 315 may, in turn, send an ISO 20022 authorization message to issuer backend 320. This authorization message may be part of the traditional process and established network rails. For example, the authorization message may travel through a card network for routing to issuer backend 320. Traditional processes and established network rails require messages in a standardized format. These messages historically conformed to ISO 8583 which may be an international standard for financial transaction card originated interchange messaging. This standard message format exists so that different systems can be integrated and together process credit card transactions. ISO 8583 may have limited size to transmit information pertaining to an authorization request.

ISO 20022 may be a new standardized message format for systems to send and receive information for the purpose of processing credit card authorization request. ISO 20022 is XML-based and lends itself to expanded data sharing. The ISO 20022 authorization message sent by merchant 315 and step 360 may include the unique user ID from mobile device/digital wallet 309. Transmitting a unique user ID with an ISO 8583 authorization message is not possible given size constraints. Indeed, prior to the present disclosure, in order for merchant 315 to transmit a unique user ID to issuer backend 320, issuer backend 320 would need to create a bespoke system to convey that information, and that information would necessarily be transmitted off of (outside of) traditional network rails. Any bespoke systems for sharing information are resource and time inefficient, as well as largely redundant (but—for technological limitations). Transferring a unique user ID in an ISO 20022 authorization message on the network rails (e.g., through a card network), addresses a technological limitation and represents an improvement to computing systems, data security, and fraud prevention.

Once issuer backend 320 receives the ISO 20022 authorization message (routed through a card network), issuer backend 320 may begin the process of rendering a transaction decision at step 365. This decision may consider traditional metrics for rendering an authorization decision such as if the digital token is correct and resolves to an active account in good standing. For example, if a transaction amount exceeds the available limit on an account, then issuer backend 320 will refuse the authorization request. Similarly, if a smart card 308 is expired, the account numbers are incorrect, the CVV is incorrect, or any other informational mismatch, issuer backend 320 may refuse the authorization request. These bases for refusal generally have nothing to do with fraud prevention (unless, for example, a transaction amount exceeds an amount that flags for potential fraud). ISO authorization messages are traditionally limited to information that does not reveal much in the way of potential fraud. However, with the unique user ID included in the ISO 20022 authorization message, issuer backend 320 has additional data with which to render a transaction decision, and this information may be indicative of attempted fraud. Issuer backend 320 may take the unique user ID provided in the ISO 20022 authorization message and compare it against a database of unique user IDs. This database of unique user IDs may be correlated with one or more of a user, an account, and an electronic device. For example, user 305 may be Bob Smith, and he may hold an account corresponding to smart card 308 and a mobile device/digital wallet 309. When Bob Smith attempts an online transaction with his digital wallet, issuer backend 320 may receive an ISO 20022 authorization message with the transaction particulars and a unique user ID. In this example the unique user ID is 1234, but this number is simply for the sake of example, real unique user IDs maybe alphanumeric and may be longer. Issuer backend 320 may take the 1234 unique user ID and search its database of user IDs. If issuer backend 320 fails to find ID 1234, then it may reject the authorization request as potentially fraudulent. This is true even if the traditional transaction information all checks out. In another embodiment, issuer backend 320 may locate ID 1234 in its database, but that ID may belong to Fred Jones. This may also cause issuer backend 320 to reject the authorization request as potentially fraudulent. The same may result if the user ID is mismatched in any way. For example, the user ID may match user 305, but not the mobile device/digital wallet 309, vice versa, or any other potential discrepancy.

In some embodiments mismatches in unique user IDs, information pertaining to unique user IDs, or even lack of a corresponding unique user ID in the issuer database may cause the issuer backend to request additional information at 362. This additional information request may include details seeking to resolve discrepancies with the unique user ID. The request may also seek to achieve confidence apart from the unique user ID. For example, the request may seek details from the digital wallet regarding authentication at step 350. This information may include how and to what degree authentication was required. At step 364, issuer backend 320 may receive the additional information from mobile device/digital wallet 309. This transmission of the request from the issuer backend 320 and the response from mobile device/digital wallet 309 may be within the framework of the ISO standard, or may be outside of the network rails and/or process. In some embodiments, issuer backend 320 may send the request of step 362 even if there is no discrepancy with the unique user ID. The decision to seek additional information may be based on any number of factors such as transaction amount, timing, IP addresses, etc., or may be utilized as a matter of course.

Once received, issuer backend 320 may use the additional information to help make an even more informed transaction decision at step 365. For example, if there is a unique user ID discrepancy, but the additional information indicates that user 205 authenticated with voice pint, facial recognition, multi-factor authentication, etc., then issuer backend 320 may approve the authorization request even in light of the discrepancy. Similarly, there may be instances where the additional information seems to confirm a fraudulent transaction and make a refusal more likely.

In the event that issuer backend is able to locate the provided unique user ID in its database and the number/information all match and are verified, then issuer backend may approve the authorization request at step 365, or as discussed, may still seek additional information at step 362 as a matter of course. At step 370, issuer backend 320 may transmit the transaction decision to merchant 315. Because this process is able to be conducted through the existing credit card authorization infrastructure, the transaction decision of step 365 and the transmission of that decision at 370 may occur in real-time, or at least substantially the same time as traditional credit card authorizations. Put another way, the sequence of FIG. 3 may not add any time to credit card transaction processing, and therefore may be seamless to user 305 and merchant 315.

Transmission of the transaction decision at step 370 may not simply be an approval or rejection. Instead, issuer backend 320 may send a notice that stepped up authentication is required prior to approval. In exemplary embodiments, this may occur if there is a unique user ID discrepancy but the information received at step 364 tends to mitigate against fraud. If the information available to issuer backend 320 is ambiguous or otherwise creates a situation where a decision could logically be made to approve or deny an authorization request, then issuer backend 320 may transmit a transaction decision seeking additional or stepped-up authentication at step 370. In such instance, the transaction processing sequence may take longer than traditional credit card transaction processing.

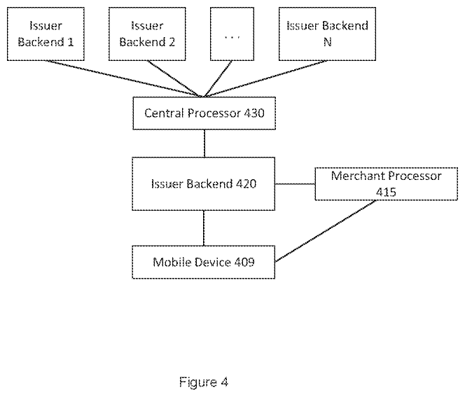

FIG. 4 describes an embodiment of exemplary systems. In FIG. 4, a central processor 430 is connected to an issuer backend 420. An issuer backend can include a processor or server associated with a provider of personal financing, including without limitation checking accounts, savings accounts, credit accounts, or some combination thereof. For example, an issuer backend can include the credit card provider associated with a user's credit card. The central processor 430 may also be connected to a plurality of additional issuer backends 1-N that may correspond to discrete banks 1-N. The design of FIG. 4 may create a hub and spoke structure where central processor 430 is the hub and each issuer backend forms a spoke from the hub.

In this embodiment, the process may be similar to that described in FIG. 2 with issuer backend 420 connected over a network to a merchant processor 415 and a mobile device 409 that includes a digital wallet. The primary difference from the embodiment of FIG. 2 is the existence of central processor 430 sitting behind the issuer backend 430. A user may still associate a smart card with mobile device 409. That process may cause the provisioning of that smart card to a digital wallet of mobile device 409. The provisioning process with issuer backend 420 may be the same as discussed with respect to FIG. 2. Issuer backend 420 may generate an provide a unique user ID to the digital wallet of mobile device 409. In some embodiments, the central processor 430 may generate the unique user IDs. In certain exemplary embodiments central processor 430 may be a standardized clearinghouse for unique user IDs for any number of issuer/bank participants.

Merchant 415 may request a form of payment for the transaction and a user of mobile device 409 may select an account stored in a digital wallet. The digital wallet may require some level of authentication before submitting payment credentials for the selected form of payment. Once completed, merchant processor 415 may send an ISO 20022 authorization message to issuer backend 420. This ISO 20022 authorization message may travel through a card authorization network. The ISO 20022 authorization message may include the unique user ID provided by the digital wallet.

The issuer backend 420 may use the compare the provided unique user ID with a databased of unique user IDs in an attempt to match the ID with the credentials for the offered form of payment. In the structure of FIG. 4, issuer processor may not maintain a database of unique user IDs. Instead, central processor 430 may maintain a database of unique user IDs. Issuer backend 420 may pass the unique user ID to central processor 430 for comparison with its database. In this scenario, central processor 430 may perform the comparison and send results back to issuer backend 420. In another embodiment, both issuer backend 420 and central processor 430 may maintain databases. This may serve as a redundancy should there be a discrepancy on issuer backend 420's database. In yet another embodiment, issuer backend may maintain the database of unique user ID's and if there is a discrepancy, it may query central processor 430. Central processor 430 may, in turn, forward the query to issuer backends 1-N. Any of those issuer backends may compare the unique user ID with their respective databases and then return results to central processor 430. Central processor 430 may provide the results to issuer backend 420. This additional step creates a network of information sharing specifically on unique user IDs for the purpose of performing credit card authorizations.

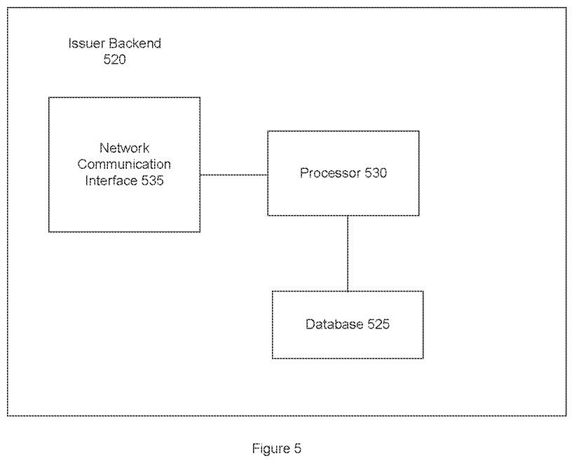

With reference to FIG. 5, issuer backend 520 may be a server such as a dedicated server computer, such as bladed servers, or personal computer, laptop computer, notebook computer, palm top computer, network computer, or any processor-controlled device capable of supporting the system 100. While FIG. 5 illustrates an issuer backend 520 that may be a single server, it is understood that other embodiments can use multiple servers or multiple computer systems as necessary or desired to support the users and can also use back-up or redundant servers to prevent network downtime in the event of a failure of a particular server. In a particular embodiment illustrated in FIG. 5, issuer backend 520 includes a processor 530 in communication with a database 525, and a network communication interface 535. The processor 530 may include a microprocessor and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. The database 525 may comprise memory and can be a read-only memory, write-once read-multiple memory or read/write memory, e.g., RAM, ROM and EEPROM, and the user device can include one or more of these memories.

The network communication interface 535 is configured to establish and support wired and/or wireless data communication capability for connecting the issuer backend 520 to the network 110 or other communication network. The network communication interface 535 can also be configured to support communication with a short-range wireless communication interface, such as Bluetooth.

In embodiments of the invention, the processor 530 may be in communication, through network communication interface 535, with a user's mobile device to send and receive ISO 20022 authorization messages containing a unique user ID for the purpose of facilitating transaction authorization decisions. Processor 530 may also be in communication with a merchant as part of the transaction authorization process and to convey approval or denial of pending transaction requests. Processor 530 may store correlated unique user IDs in database 525. Additionally, processor 530 may access and cross reference a directory of unique user ID's to confirm identities from database 525. Processor 530 may use this information to make a transaction authorization decision for a pending transaction.

A transaction decision may approve or deny a pending transaction authorization request. This decision may be part of a card network's traditional authorization process and simply represent a new and improved process based in the technical capability of embedding a unique user ID in an ISO authorization message. Further, this new authorization process may occur in real-time or substantially the same time frame as traditional transaction authorization decisions. In some embodiments, the authorization decision may be different than what would be produced by traditional authorization. Because an authorization decision of exemplary embodiments of the present disclosure are based on more and/or better information than traditional authorization decisions, these authorization decisions may override traditional decisions.

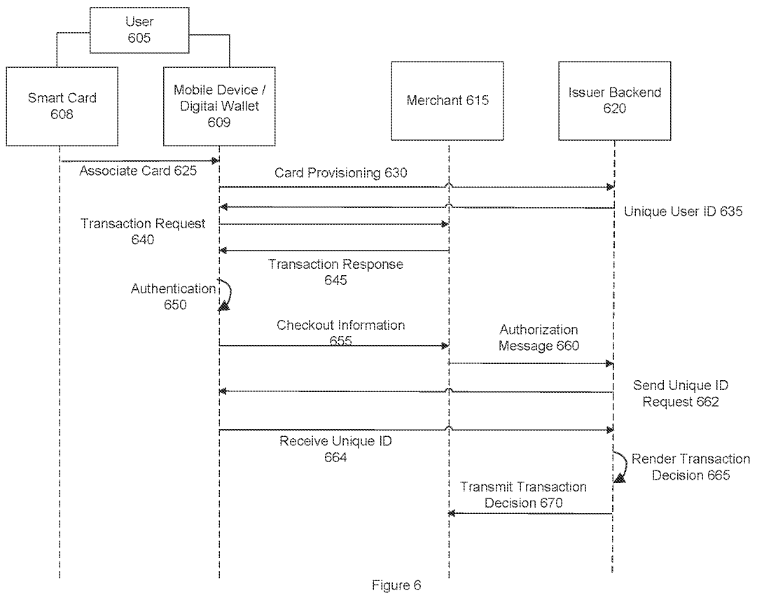

The sequence diagram of FIG. 6 illustrates an exemplary application of embodiments of the invention in conjunction with the system 100 of FIG. 1. In the scenario set forth in FIG. 6, a user 605 has a smart card 608 and a mobile device/digital wallet 609. The mobile device/digital wallet 609 is in communication with a merchant 615 and in some embodiments, an issuer backend 620. Mobile device/digital wallet 609 may be a personal computer, smart phone, smart watch, or any other network enabled computing device. Mobile device/digital wallet 609 may include memory, a network communication, an interactive user interface, and a processor capable of running one or more software applications and a digital wallet. Smart card 608 may be any chip enabled credit card or the like. Smart card 608 may be in communication with mobile device/digital wallet 609 via Bluetooth, NFC, or any other suitable short range communication protocol.

Issuer backend 620 may include one or more processors and may be in communication with mobile device/digital wallet 609 and merchant 615. Backend 620 may be configured to transmit to and receive data from merchant 615 pertaining to a purchase transaction, as well as mobile device/digital wallet 609.

Merchant 615 may include one or more processors and memory, as well as storage. It may be configured to run one or more websites, apps, etc. It may be further configured to provide a consumer facing sales interface that enables consumer shopping and purchase transactions of one or more goods or services on a website or app associated with merchant 615. It may be configured to communicate with backend 620 in order to transmit transaction requests as well as share consumer data.

User 605 may hold smart card 608 that may be associated with an issuer and/or one or more financial and/or credit accounts, etc. with that issuer. User 605 may also have a mobile device/digital wallet 609. When user 605 makes online purchases, he or she may be required to enter payment information in an interface provided by merchant 615. Entry of this information may be cumbersome and time consuming as it requires finding the desired smart card, which often is not on the user 605 at the time of the attempted purchase. Then user 605 must manually enter the card information including the name on the card, the card number, an expiration date, and the CVV number. A user may be willing to follow this process if he or she only occasionally shops online. However, if a person frequently shops online, this process becomes a real barrier, especially when compared to the credit card usage process at a brick and mortar store. In those instances, a consumer usually inserts a card into or taps the card against a POS terminal. That is the sole requirement-no name entry, card number entry, etc. Thus, user 605 may seek a better and more efficient way to use his or her smart card 608 in connection with online purchases. The digital wallet is an answer to the problems with traditional online purchase transactions. Digital wallets store a user's cards digitally, thereby obviating the need to manually enter all of the credit card information each time an online transaction is attempted. When an online purchase transaction is attempted, a user may simply open his or her digital wallet (or otherwise be prompted to use his or her digital wallet). Then the user may select a digital card for payment, the digital card representing an financial account held with an issuer/bank. The user is not required to then manually enter any credit card information, but may be required to perform some sort of authentication. Thus, at step 625, user 605 may be incentivized to associate smart card 608 with a digital wallet of mobile device/digital wallet 609.

Associating smart card 608 with mobile device/digital wallet 609 may normally entail manually entering the card details much like a traditional online purchase transaction. The difference, of course, is that this information only has to be entered once as opposed to every time an online purchase is made. However, in some embodiments, smart card 608 may be associated with mobile device/digital wallet 609 through any technological means, including but not limited to NFC, Bluetooth, etc. The association of smart card 608 may permit and/or enable mobile device/digital wallet 609 to collect and/or store information pertaining to user 605 as well as the user's account(s) associated with smart card 608.

As a result of card association at step 625, card provisioning may occur at step 630. In order for a digital wallet to function, there often is a backend setup required between the digital wallet and the issuer/bank, in this case between mobile device/digital wallet 609 and issuer backend 620. In the case of many digital wallets, this process involves digital tokenization of each smart card associated with the digital wallet. The tokenization process may involve the mobile device/digital wallet 609 sending a provisioning request to issuer backend 620 that may include sending the card details for verification/authorization. If these card details are confirmed and issuer backend 620 is confident that the card is correct, it may provide a digital token that represents the card, such that mobile device/digital wallet 609 is not required to store sensitive card information. In future transactions, mobile device/digital wallet 609 may provide the digital token that represents the account instead of the sensitive card information.

In exemplary embodiments, issuer backend 620 may create a unique user ID. This unique user ID may correspond to user 605, to mobile device/digital wallet 609, to smart card 608, or to any combination thereof. Issuer backend 620 may determine a scheme whereby a single unique user ID is sufficient for a given user, or may want multiple unique user ID for as many smart card/accounts as held by a given user. Similarly, in some exemplary embodiments, a user may have different unique user IDs for the same smart card/account on a per-electronic device basis. Other combinations or schemes may be possible. In some exemplary embodiments, a 3rd party may be responsible for creating unique user IDs instead of the issuer backend 620. To the extent that systems and methods disclosed herein become an industry standard, there could be an accepted third-party clearinghouse for unique user IDs.

Issuer backend 620 may store the unique user ID created in response to the card provisioning at step 630. At step 635, issuer backend 620 may send the unique user ID to the mobile device/digital wallet 609 for integration with the smart card 608 or with a digital token representing smart card 608 (or an account for smart card 608). The digital wallet may be responsible for storing and maintaining the unique user ID on user 605's end of the system/method architecture.

At 640, mobile device/digital wallet 609 may transmit a transaction request to merchant 615. User 605 may shop for goods on mobile device/digital wallet 609. The shopping may be directly connected to merchant 615. For example, the shopping may take place on a website hosted by merchant 615 or an app developed and/or supported/hosted by merchant 615. Shopping on mobile device/digital wallet 609 may include adding one or more products to a virtual cart and then initiating a virtual checkout process for those one or more products. The act of checking out with one or more products may result in mobile device/digital wallet 609 transmitting a transaction request to merchant 615 at step 640. In response to the transaction request of 640, merchant 615 may provide a transaction response at step 645. The transaction response may include merchant 615 requesting a method of payment. This step may also include any sort of login to a user account for a merchant website and/or providing other credentials.

As a result of merchant 615 requesting a form of payment, user 605 may select/open his or her digital wallet. In some embodiments, a digital wallet may monitor attempted purchase transaction and provide a pop-up message offering use of a digital wallet to provide a form of payment in response to merchant 615. In any event, user 605 may select a smart card/account from the digital wallet that he or she wishes to use to complete the requested transaction. In this example, user 605 may select smart card 608, or a digital token representing smart card 608, from his or her digital wallet.

Mobile device/digital wallet 609 may require some form of authentication at step 650 prior to allowing use of any associated card/account. This authentication may include facial recognition, fingerprint, voice print, or any other potential biometric. The authentication may also include more traditional user ID and password combinations. In some embodiments, there may be combinations of authentication required as well as stepped up and/or stepped down authentication depending on any number of factor. For instance, after initial authentication, digital wallet may send a text with a verification code to an associated phone number and/or email address as a form of multi-factor authentication.

Once mobile device/digital wallet 609 has successfully authenticated user 605 at step 650, mobile device/digital wallet 609 may provide an authorization message to merchant 615. This authorization message may conform to an industry standard format such as ISO 20022. The checkout information may include card information, or in some instances, the digital token representing smart card 608. Some or all of the information conveyed at step 655 may be encrypted.

Merchant 615 may, in turn, send an ISO 20022 authorization message to issuer backend 620 at step 660. This authorization message may be part of the traditional process and established network rails. For example, the authorization message may travel through a card network for routing to issuer backend 620. Traditional processes and established network rails require messages in a standardized format. These messages historically conformed to ISO 8583 which may be an international standard for financial transaction card originated interchange messaging. This standard message format exists so that different systems can be integrated and together process credit card transactions. ISO 8583 may have limited size to transmit information pertaining to an authorization request. ISO 20022 may be a new standardized message format for systems to send and receive information for the purpose of processing credit card authorization request. ISO 20022 is XML-based and lends itself to expanded data sharing.

At step 662, issuer backend 620 may, as a result of receiving the authorization message at step 660, send a request for the unique user ID to mobile device/digital wallet 609. This request may identify the pending transaction and transaction details. In some embodiments, the request may comprise an ISO 20022 authorization message with details sufficient for a digital wallet to identify the relevant unique user ID. In some embodiments, this may be considered last step provisioning. Mobile device/digital wallet 609 may, in response to the request, send the unique user ID for user 605, smart card 608, and/or mobile device/digital wallet 609 as the case may be. These transmissions from issuer backend 620 to mobile device/digital wallet 609 and vice versa may be ISO 20022 authorization messages.

As discussed with respect to other figures, transmitting a unique user ID with an ISO 8583 authorization message is not possible given size constraints. Indeed, prior to the present disclosure, in order for merchant 615 to transmit a unique user ID to issuer backend 620, issuer backend 620 would need to create a bespoke system to convey that information, and that information would necessarily be transmitted off of (outside of) traditional network rails. Any bespoke systems for sharing information are resource and time inefficient, as well as largely redundant (but—for technological limitations). Transferring a unique user ID in an ISO 20022 authorization message on the network rails (e.g., through a card network), addresses a technological limitation and represents an improvement to computing systems, data security, and fraud prevention.

Once issuer backend 620 receives the ISO 20022 authorization message including the unique user ID from mobile device/digital wallet 609, issuer backend 620 may begin the process of rendering a transaction decision at step 665. This decision may consider traditional metrics for rendering an authorization decision such as if the digital token is correct and resolves to an active account in good standing. For example, if a transaction amount exceeds the available limit on an account, then issuer backend 620 will refuse the authorization request. Similarly, if a smart card 608 is expired, the account numbers are incorrect, the CVV is incorrect, or any other informational mismatch, issuer backend 620 may refuse the authorization request. These bases for refusal generally have nothing to do with fraud prevention (unless, for example, a transaction amount exceeds an amount that flags for potential fraud). ISO authorization messages are traditionally limited to information that does not reveal much in the way of potential fraud. However, with the unique user ID included in the ISO 20022 authorization message, issuer backend 620 has additional data with which to render a transaction decision, and this information may be indicative of attempted fraud. Issuer backend 620 may take the unique user ID provided in the ISO 20022 authorization message and compare it against a database of unique user IDs. This database of unique user IDs may be correlated with one or more of a user, an account, and an electronic device. For example, user 605 may be Bob Smith, and he may hold an account corresponding to smart card 608 and a mobile device/digital wallet 609. When Bob Smith attempts an online transaction with his digital wallet, issuer backend 620 may receive an ISO 20022 authorization message with the transaction particulars and a unique user ID. In this example the unique user ID is 1234, but this number is simply for the sake of example, real unique user IDs maybe alphanumeric and may be longer. Issuer backend 620 may take the 1234 unique user ID and search its database of user IDs. If issuer backend 620 fails to find ID 1234, then it may reject the authorization request as potentially fraudulent. This is true even if the traditional transaction information all checks out. In another embodiment, issuer backend 620 may locate ID 1234 in its database, but that ID may belong to Fred Jones. This may also cause issuer backend 620 to reject the authorization request as potentially fraudulent. The same may result if the user ID is mismatched in any way. For example, the user ID may match user 605, but not the mobile device/digital wallet 609, vice versa, or any other potential discrepancy. In the event that issuer backend is able to locate the provided unique user ID in its database and the number/information all match and are verified, then issuer backend may approve the authorization request at step 665.

At step 670, issuer backend 620 may transmit the transaction decision to merchant 615, which may complete the online purchase by user 605. Because this process is able to be conducted through the existing credit card authorization infrastructure, the transaction decision of step 265 and the transmission of that decision at 270 may occur in real-time, or at least substantially the same time as traditional credit card authorizations. Put another way, the sequence of FIG. 6 may not add any time to credit card transaction processing, and therefore may be seamless to user 205 and merchant 215.

In exemplary embodiments, transmission of the transaction decision at step 670 may not simply be an approval or rejection. Instead, issuer backend 620 may send a notice that stepped up authentication is required prior to approval. In exemplary embodiments, this may occur if the information available to issuer backend 620 is ambiguous or otherwise creates a situation where a decision could logically be made to approve or deny an authorization request. In these circumstances, issuer backend 620 may transmit a transaction decision seeking additional or stepped-up authentication at step 670. In such instance, the transaction processing sequence may take longer than traditional credit card transaction processing.

It is noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, e.g., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, e.g., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

We claim:

1. A method for authorizing transaction requests, the method comprising the steps of:
receiving, by a processor, a provisioning request for a digital wallet;
sending, as a result of the provisioning request, a unique user identifier (ID) to the digital wallet;
receiving, by the processor, an authorization message from a merchant comprising:
one or more transaction details; and
the unique user ID; and
transmitting, by the processor, a transaction decision based on the unique user ID.

2. The method of claim 1, further comprising:
generating, by the processor, the unique user ID.

3. The method of claim 1, further comprising:
storing, in a database, the unique user ID.

4. The method of claim 1, wherein the transaction request further comprises one or more details regarding authentication of the digital wallet.

5. The method of claim 1, further comprising:
comparing, by the processor, the unique user ID against a database of unique user IDs, each correlated to a user.

6. The method of claim 5, further comprising:
confirming the identity of an owner of the digital wallet by finding a match between the unique user ID and an entry in the database of unique user IDs.

7. The method of claim 1, wherein in response to receiving the authorization message including the unique user ID, sending, by the processor, a request for additional information directly to the digital wallet.

8. The method of claim 7, wherein the transaction decision is further based on a response to the request for additional information sent to the digital wallet.

9. The method of claim 1, further comprising:
sending, via the processor, the unique user ID from the authorization message to a central processor connected to a plurality of issuers or a plurality of banks.

10. The method of claim 9, further comprising:
receiving, via the processor, feedback from the central processor, the feedback comprising user identity information for the unique user ID from the authorization message from one or more of the plurality of issuers or a plurality of banks.

11. A method for authorizing transaction requests, the method comprising the steps of:
receiving, by a processor, a provisioning request for a digital wallet;
sending, as a result of the provisioning request, a unique user identifier (ID) to the digital wallet;
receiving, by the processor, a merchant authorization message;
sending, by the processor and as a result of the merchant authorization message, a first authorization message to the digital wallet, the first authorization message including a unique user ID request;
receiving, by the processor, a second authorization message from the digital wallet, the second authorization message including the unique user ID; and
transmitting, by the processor, a transaction decision based on the unique user ID.

12. A system for authorizing transaction requests, the system comprising:
a processor configured to:
receive a provisioning request for a digital wallet;
send a unique user identifier (ID) to the digital wallet;
receive an authorization message from a merchant comprising:
one or more transaction details; and
the unique user ID; and
transmitting, by the processor, a transaction decision based on the unique user ID.

13. The system of claim 12, further comprising:
a database configured to store the unique user ID.

14. The system of claim 12, wherein the transaction request further comprises one or more details regarding authentication of the digital wallet.

15. The system of claim 12, wherein the processor is further configured to compare the unique user ID against a database of unique user IDs, each correlated to a user.

16. The system of claim 15, wherein the processor is further configured to confirm the identity of an owner of the digital wallet by finding a match between the unique user ID and an entry in the database of unique user IDs.

17. The system of claim 12, wherein in response to receiving the authorization message including the unique user ID, the processor is configured to send a request for additional information directly to the digital wallet.

18. The system of claim 17, wherein the transaction decision is further based on a response to the request for additional information sent to the digital wallet.

19. The system of claim 12, wherein the processor is further configured to send, via the processor, the unique user ID from the authorization message to a central processor connected to a plurality of issuers or a plurality of banks.

20. The system of claim 19, wherein the processor is further configured to receive feedback from the central processor, the feedback comprising user identity information for the unique user ID from the authorization message from one or more of the plurality of issuers or a plurality of banks.
